(19) United States
(12) Patent Application Publication
(10) Pub. No.: US 2013/0107340 A1
(43) Pub. Date: May 2, 2013

(54) Autostereoscopic Steering Light-Guide Three-Dimensional Displays

(71) Applicants: Yoon Kean Wong, Redwood City, CA (US); Chun Wun Steve Yeung, Santa Clara, CA (US)

(72) Inventors: Yoon Kean Wong, Redwood City, CA (US); Chun Wun Steve Yeung, Santa Clara, CA (US)

(21) Appl. No.: 13/285,469

(22) Filed: Oct. 31, 2011

(51) Int. Cl. G02B 27/22; G02B 26/08

(52) U.S. Cl. 359/222.1; 359/462

(57) ABSTRACT

An autostereoscopic steering light-guide three-dimensional display. The display includes a light modulator, a light guide in light-transmitting orientation to the light modulator, a light source in light-transmitting orientation to the light guide, and a control element adjacent the light guide. The control element is responsive to a first command to cause the light guide to steer light from the light source in a first direction through the light modulator and responsive to a second command to cause the light guide to steer light from the light source in a second direction through the light modulator.

### BACKGROUND

A display is an electronic output device that presents information in the form of a visual image, typically in two dimensions. Examples of displays that provide two-dimensional images are computer monitors and television screens. Humans perceive what they see in three dimensions because the left eye has a slightly different perspective than the right eye, and therefore each eye produces a slightly different image. The brain integrates the left and right images, resulting in a three-dimensional perception. There has been much research and development respecting displays that can provide three-dimensional perceptions. One relatively well-known technique involves encoding two views that approximate the perspectives of an observer's two eyes, for example by tinting one view red and the other green or by polarizing them in orthogonal orientations. The encoded views are reproduced by the display, and the observer looks at the display through tinted or polarized eyeglasses or some other optical device that directs one view to the left eye and the other to the right eye. A promising new technique, autostereoscopy, avoids any need for the observer to use special eyeglasses or other optical devices. Examples of autostereoscopic displays include parallax barrier, lenticular, volumetric, electro-holographic, and light field displays.

### BRIEF DESCRIPTION OF THE DRAWINGS

The drawings illustrate by example implementations of the invention.

FIG. 1 is a cross-sectional view of an example of an autostereoscopic steering light guide three-dimensional display including a serrated light guide surface.

FIG. 2 is a cross-sectional view of an example of a display similar to that shown in FIG. 1 but with a flat-peak and flat-valley light guide surface.

FIG. 3 is a cross-sectional view of an example of an autostereoscopic steering light guide three-dimensional display including a serrated light guide surface adjacent a light modulator.

FIG. 4 is a flow chart of an example of a method of generating an autostereoscopic three-dimensional image.

### DETAILED DESCRIPTION

In the drawings and in this description, examples and details are used to illustrate principles of the invention. Other configurations may suggest themselves. Parameters such as dimensions are approximate. Terms of orientation such as up, down, top, and bottom are used only for convenience to indicate spatial relationships of components with respect to each other, and except as otherwise indicated, orientation with respect to external axes is not critical. Some known methods and structures have not been described in detail in order to avoid obscuring the invention. Accordingly, the invention may be practiced without limitation to the details and arrangements as described. The invention is to be limited only by the claims, not by the drawings or this description.

Autostereoscopic displays can provide an observer with a three-dimensional perception without any need to use special optical devices such as tinted or polarized eyeglasses. Such displays have suffered from limited resolution or low power efficiency and unacceptable border width. There is a need for an autostereoscopic display that provides a crisp, high-resolution image with high power efficiency and without border width issues.

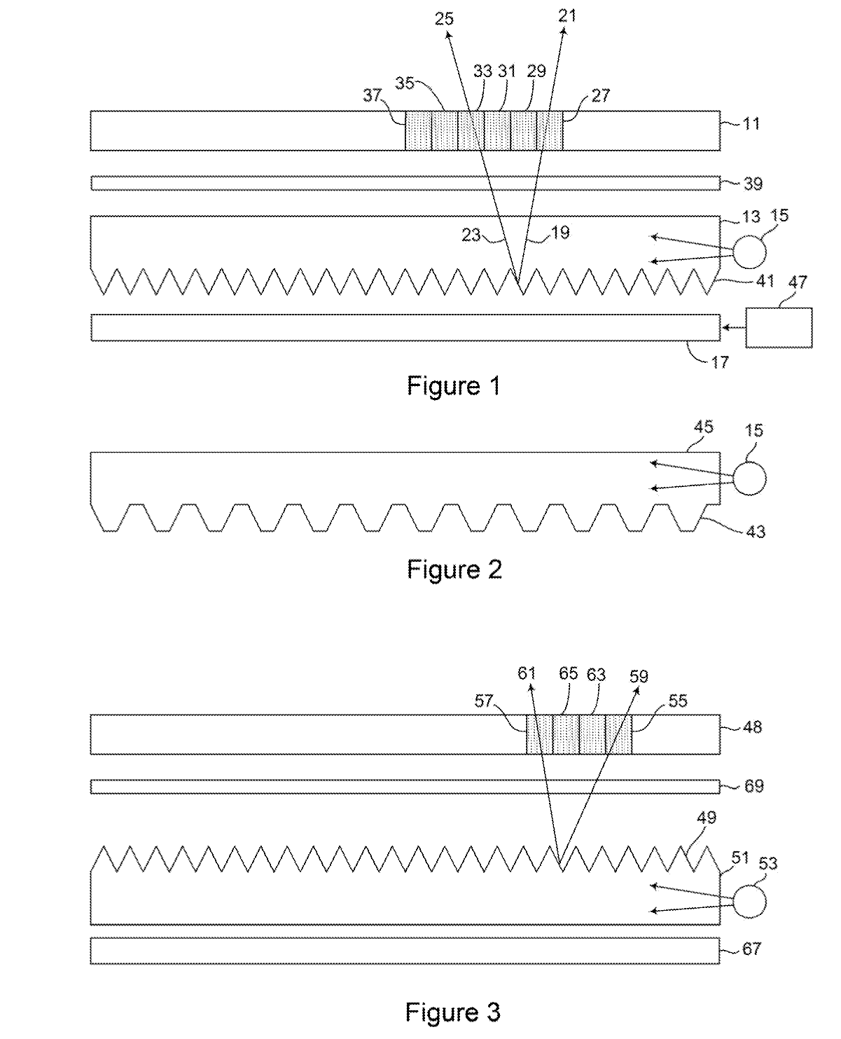

An embodiment of an autostereoscopic steering light-guide three-dimensional display is shown in FIG. 1. The display includes a light modulator 11, a light guide 13 in light-transmitting orientation to the light modulator, a light source 15 in light-transmitting orientation to the light guide, and a control element 17 adjacent the light guide. In some embodiments the light source comprises a single light emitter such as a light-emitting diode (LED) adjacent an edge of the light guide. The control element 17 is responsive to a first command to cause the light guide 13 to steer light 19 from the light source 15 in a first direction 21 through the light modulator 11 and responsive to a second command to cause the light guide to steer light 23 from the light source in a second direction 25 through the light modulator.

As indicated by the first direction 21, the light 19 propagates toward an assumed location for one eye of the observer. Similarly, the light 23 propagates toward an assumed location for the other eye, as indicated by the second direction 25.

The light modulator may comprise a liquid-crystal display (LCD) panel with pixels arranged in alternating sets for the left eye and the right eye. For example, a set of pixels for the left eye may comprise a red pixel 27, an adjacent green pixel 29, and an adjacent blue pixel 31. An adjacent set of pixels for the right eye: may comprise a red pixel 33 adjacent the left-eye blue pixel 31, an adjacent green pixel 35, and an adjacent blue pixel 37.

The light 19 is shown passing through the left-eye red pixel 27 and the light 23 is shown passing through the right-eye red pixel 33. The left-eye red pixel 27 modulates the light 19 to provide red-colored light with a correct intensity for a corresponding point in an image then being displayed. The pixels 29 and 31 modulate other light (not shown) to provide, respectively, green- and blue-colored light at a correct intensity for the same point. The red, green and blue light combine to provide a desired color for, for example, the left-eye image at that point. Similarly, the right-eye pixels 33, 35, and 37 modulate the light 23 and other light (not shown) to provide a desired color for, continuing the same example, the right-eye image at that point.

The light guide 13 may also provide other light beams at other angles. These light beams may pass through the pixels in wrong directions and interfere with correct display of the image. Accordingly, in some embodiments an optical mask 39 is disposed between the light guide 13 and the light modulator 11 to attenuate any such unwanted light beams and thereby prevent them from interfering. The mask may either block such unwanted beams of light or reduce their intensity.

In FIG. 1, the control element, light guide, optical mask if used, and light modulator are shown spaced apart from each other. This space may be air-filled. Air has a permittivity E of 1. The light guide may be fabricated of material with a permittivity E in the range of 3 to 4. In some embodiments two or more of these elements may be mounted in direct contact with each other, for example by being glued directly to each other, with no intervening air.

The light guide, may comprise a prism coupler such as an FTIR (Frustrated Total Internal Reflection) coupler. As shown in FIG. 1, this coupler may have a serrated light-guide surface 41 adjacent the light source. In another embodiment, the coupler may take the form of a flat-peak and flat-valley surface 43 in a light guide 45, as shown in FIG. 2.

Some embodiments include a control signal source 47 in electrical communication with the control element. This control signal source may be included in a video display driver that also drives the light modulator 11. The control signal source may generate an electric field between the control element and the prism coupler, the prism coupler being deformable in response to the electric field. By applying appropriate voltages to the control element in sync with the video display, the prism coupler is deformed under the influence of the electric field just enough to deflect the light to the right eye, when the modulator is modulating the light in accordance with a right-eye image, and to the left eye when the modulator is modulating the light in accordance with a left-eye image.

Another embodiment of a light-guide backlight three-dimensional display is shown in FIG. 3. This embodiment is similar to that shown in FIG. 1 except that a light modulator 48 is adjacent a serrated edge 49 of a light guide 51, whereas in the embodiment of FIG. 1 the serrated edge 41 of the light guide 13 is on a surface of the; light guide opposite the modulator 11. A light source 53 provides light that is steered by the light guide through pixels 55 and 57 in first and second directions 59 and 61, respectively, of the light modulator 48. As in the embodiment in FIG. 1, the light modulator 48 includes other pixels such as the pixels 63 and 65 between the pixels 55 and 57, which may be disposed in alternating colors. A control element 67 deforms the light guide 51, for example by establishing an electric field between the control element and the light guide. An optical attenuator 69 may be provided to attenuate light propagating in directions other than the first and second directions.

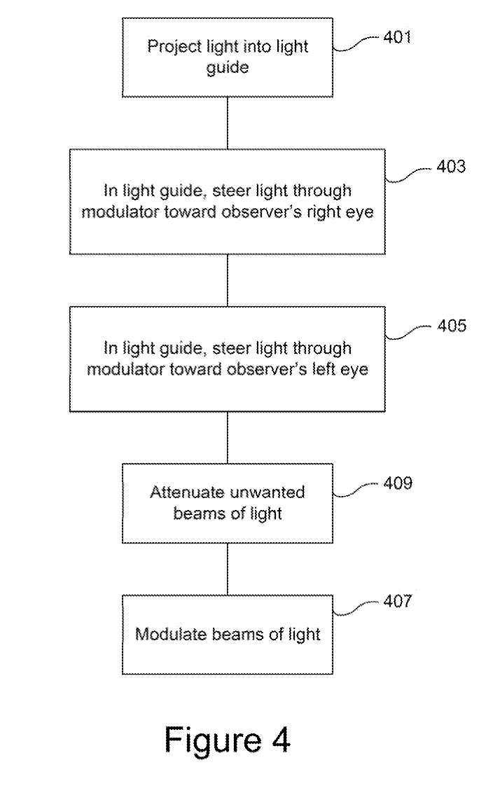

A method of generating an autostereoscopic three-dimensional image in a light-guide backlight is shown in FIG. 4. Light is projected into a light guide (401). In the light-guide, light is steered in a first direction through a light modulator toward a location for an observer's right eye (403). In the light guide, light is steered in a second direction through the light modulator toward a location for the observer's left eye (405). The light is modulated (407).

Some embodiments may include attenuating unwanted light beams, for example those propagating in a direction other that the first or second directions (409).

The light may be steered by deforming the light guide, for example by applying an electric field to the light guide. The field may be applied through a control element adjacent the light guide. The field may be produced by a control signal generated by a signal source such as a video display driver and may be synchronized with signals provided to the light modulator so that light is steered toward the right eye when the modulator is modulating according to a desired right-eye image and toward the left eye when the modulator is modulating according to a desired left-eye image.

An autostereoscopic light-guide backlight three-dimensional display as described above provides a high-resolution three-dimensional image to an observer with high power efficiency. The observer does not need to wear stereoscopic eyeglasses or use other optical devices to perceive the image. In some embodiments single light source such as an LED is sufficient to drive the display, significantly reducing the power consumed by the display when compared with displays that require multiple light sources.

We claim:

1. An autostereoscopic steering light-guide three-dimensional display comprising:
a light modulator;
a light guide in light-transmitting orientation to the light modulator;
a light source in light-transmitting orientation to the light guide; and
a control element adjacent the light guide,
the control element responsive to a first command to cause the light guide to steer light from the light source in a first direction through the light modulator and responsive to a second command to cause the light guide to steer light from the light source in a second direction through the light modulator.

2. The display of claim 1 and further comprising an optical mask disposed between the light guide and the light modulator, the optical mask oriented to attenuate light propagating in directions other than the first and second directions.

3. The display of claim 1 wherein the light, source comprises a single light-emitting element.

4. The display of claim 1 wherein the permittivity of the light guide is higher than the permittivity of air.

5. The display of claim 1 wherein the light guide comprises a frustrated total internal reflection prism coupler.

6. The display of claim 5 wherein the prism coupler comprises a serrated surface.

7. The display of claim 5 wherein the prism coupler comprises a surface having alternating flat peaks and flat valleys.

8. The display of claim 5 and further comprising a control signal source in electrical communication with the control element.

9. The display of claim 5 wherein the control signal source generates an electric field between the control element and the prism coupler and wherein the prism coupler is deformable in response to the electric field.

10. A method of generating an autostereoscopic three-dimensional image comprising:
projecting light into a light guide; responsive to a steering command, steering the light in a first direction through a light modulator toward a location for an observer's right eye;
responsive to the steering command, steering the light in a second direction through the light modulator toward a location for the observer's left eye; and
modulating the beams in the light modulator.

11. The method of claim 10 wherein the light guide comprises a frustrated total internal reflection prism coupler.

12. The method of claim 11 wherein steering the light comprises deforming the prism coupler.

13. The method of claim 12 wherein deforming the prism coupler comprises applying an electric field to the prism coupler.

14. The method of claim 11 wherein the prism coupler comprises one of a serrated surface and a flat-peaks-and-flat-valleys surface.

15. The method of claim 10 and further comprising attenuating light propagating from the light guide in a direction other than the first or second directions.
